(19) United States
(12) Patent Application Publication
(10) Pub. No.: US 2026/0194690 A1
(43) Pub. Date: Jul. 9, 2026

(54) No Freeze Rain Guage

(71) Applicant: Mary Bernadette Hovel, La Crosse, WI (US)

(72) Inventor: Mary Bernadette Hovel, La Crosse, WI (US)

(21) Appl. No.: 18/445,715

(22) Filed: Dec. 26, 2023

Related U.S. Application Data
(60) Provisional application No. 63/475,934, filed on Jan. 3, 2023.

(51) Int. Cl. G01W 1/14

(52) U.S. Cl. CPC G01W 1/14

(57) ABSTRACT

A rain and snow measuring device of nonbreakable silicone and light metal for usage in all types of weather or climate with out breaking and loosing measured amount.

### FIELD

The present application relates to a rain gauge, a precipitation measuring device, that can be left out all four seasons but not break, and can act as a snow measuring device as well.

### BACKGROUND

Rain gauges of plastic or glass have limited life in areas of the country that get freezing weather. If it rains in the daytime in fall or spring then freezes at night, the gauge often breaks. The material used for this rain gauge measuring device will be out of a flexible silicone allowing it to freeze, not break, and easily remove the ice accumulated in the gauge. The pole that will hold the said rain device and allow for insertion into the ground will be a snow measuring device as well.

### SUMMARY

By providing a flexible, nonbreakable silicone material with incremental measurements to hold rain, that inserts into a holder in a sturdy silicone pole with incremental measurements will allow all weather measuring of precipitation, such as rain and snow.

Further features, and properties of the device will be better identified with the description of the drawings.

### BRIEF DESCRIPTION OF THE DRAWINGS

FIG. 1: Shows various views of bottom section of measuring pole that will include:

FIG. 1A Shows top view of the inner and outer diameter of bottom section of a three

FIG. 1B shows side angle of bottom section of pole, note the point at bottom for inserting into the ground, and the incremental markings for measuring.

FIG. 2: Shows view of middle section (2 of these needed) of measuring pole that include:

FIG. 2A shows top view of the next two pole sections with inner and outer diameters noted

FIG. 2B shows side angle of the identical middle sections (two needed) again with incremental markings.

FIG. 3: Shows various views of gauge cup holder that include:

FIG. 3A shows top view of the gauge holder that inserts into said pole in previous figure (FIG. 2).

FIG. 3B shows side view of said gauge holder.

FIG. 4: Shows various views of rain gauge cup measuring device that includes:

FIG. 4A shows top view of opening diameter of the rain gauge for measuring precipitation. This said cup inserts into said gauge holder (FIG. 3)

FIG. 4B shows side angle of the rain gauge device with incremental markings for measuring.

FIG. 5 Is a view of said portions noted in previous figures (FIG. 1B, FIG. 2B, FIG. 3B, FIG. 4B) and how they assemble together. Noting that TWO sections of FIG. 2B are needed.

### DETAILED DESCRIPTION

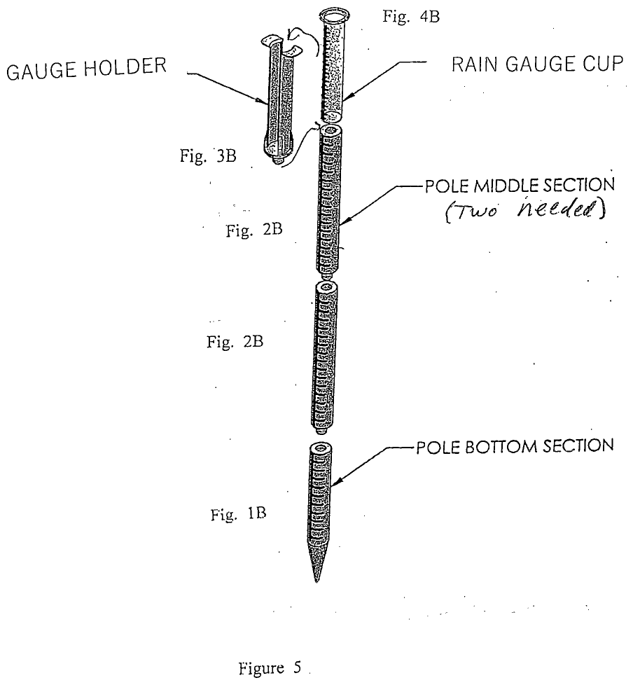

The non freezable rain/snow gauge comprises of 5 portions making 3 different components, see FIG. 5.

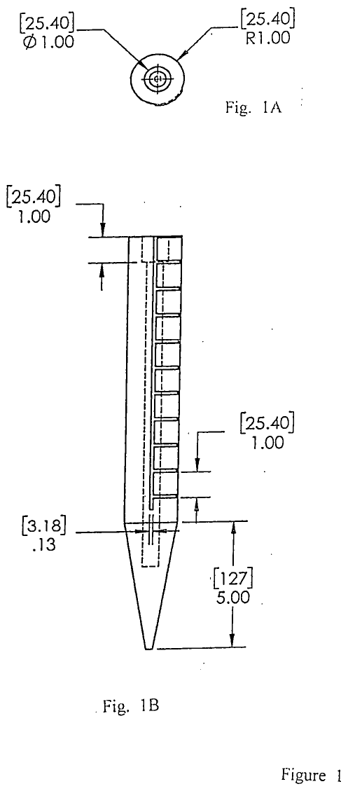

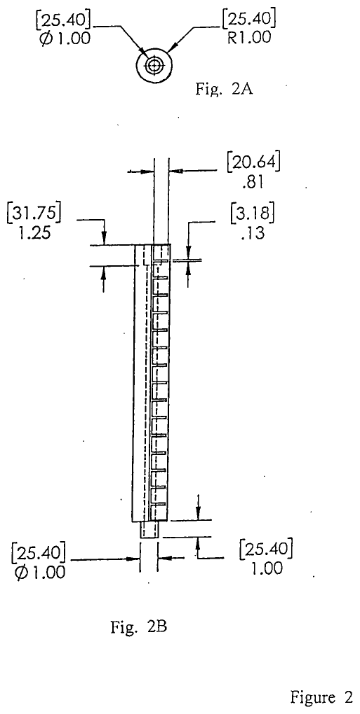

Three of the five portions will form one component hereby referred to as the pole (FIG. 1, FIG. 2). The bottom portion of the pole has a point that inserts into the ground (FIG. 1B). Each portion of the said pole has incremental markings for snow measuring (FIG. 1B, FIG. 2B). These portions are fabricated of a sturdy silicone to prevent breakage in cold weather.

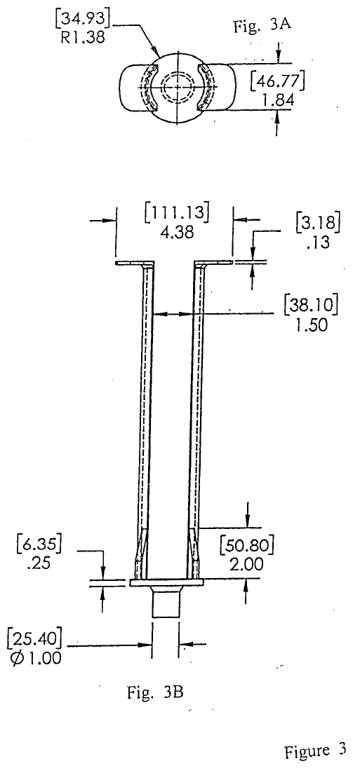

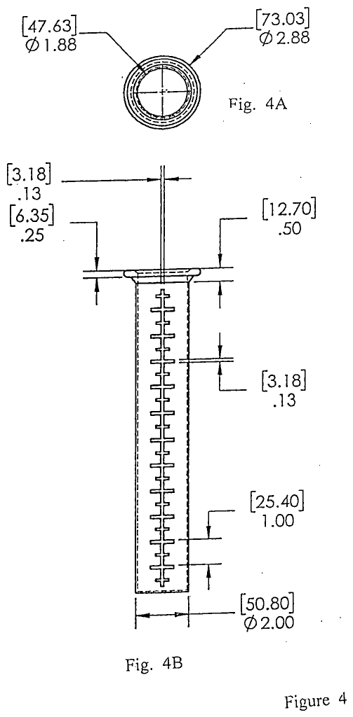

One portion of the said five portions is an aluminum gauge holder (FIG. 3) that inserts into top section of said pole (FIG. 2A) and will hold the gauge cup shown in FIG. 4.

The remaining portion is the rain gauge device depicted in FIG. 4, made of flexible silicone with incremental markings. This said gauge will insert into the said holder (FIG. 3) and be the device that will hold and measure the rainfall.

1. A non-breakable rain, and snow measuring device comprising of:
a three section silicone pole with incremental markings of which the lower section has a tapered point; (see FIGS. 1B, and 2B)
a light metal gauge holder that inserts into top portion of said pole; (see FIG. 3B)
a flexible silicone gauge tube with incremental markings that inserts into said holder. (see FIG. 4B)
